(19) United States
(12) Patent Application Publication
(10) Pub. No.: US 2006/0248921 A1
(43) Pub. Date: Nov. 9, 2006

(54) Landfill gas purification and liquefaction process

(76) Inventors: Christian S. Hosford, Kennebunkport, ME (US); Heather Noel James, Portsmouth, NH (US)

Correspondence Address: Mark J. Pandiscio;Pandiscio & Pandiscio, P.C., 470 Totten Pond Road, Waltham, MA, 02451-1914, US

(21) Appl. No.: 11/282,163

(22) Filed: Nov. 18, 2005

Related U.S. Application Data
(60) Provisional application No. 60/629,055, filed on Nov. 18, 2004.

(51) Int. Cl. B01D 53/02; F25J 1/00

(52) U.S. Cl. 62/611; 95/95

(57) ABSTRACT

A process for manufacturing liquid methane from a feedstock gas, wherein the feedstock gas is obtained from an alternative gas source generated by anaerobic digestion and comprising methane, carbon dioxide, nitrogen, oxygen, water vapor and hydrogen sulfide, the process comprising the steps of: (i) removing from the feedstock gas constituents which are incompatible with liquefaction, wherein removal is effected by pressure swing absorption, whereby to yield a mixture comprising methane, nitrogen and oxygen; and (ii) liquefying the mixture by cooling, and adjusting the temperature during cooling so-as to remove nitrogen and oxygen, whereby to yield an output consisting primarily of liquid methane.

### REFERENCE TO PENDING PRIOR PATENT APPLICATION

This patent application claims benefit of pending prior U.S. Provisional Patent Application Ser. No. 60/629,055, filed Nov. 18, 2004 by Christian S. Hosford et al. for LANDFILL GAS PURIFICATION AND LIQUEFACTION PROCESS (Attorney Docket No. CRYO-1A PROV), which patent application is hereby incorporated herein by reference.

### SUMMARY OF THE INVENTION

In one form of the invention there is provided a process for manufacturing liquid methane from a feedstock gas, wherein the feedstock gas is obtained from an alternative gas source generated by anaerobic digestion and comprising methane, carbon dioxide, nitrogen, oxygen, water vapor and hydrogen sulfide, the process comprising the steps of:
(i) removing from the feedstock gas constituents which are incompatible with liquefaction, wherein removal is effected by pressure swing absorption, whereby to yield a mixture comprising methane, nitrogen and oxygen; and
(ii) liquefying the mixture by cooling, and adjusting the temperature during cooling so as to remove nitrogen and oxygen, whereby to yield an output consisting primarily of liquid methane.

### BRIEF DESCRIPTION OF THE DRAWINGS

This and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 is a schematic view of a system and method of the present invention;

FIG. 2 is a is a schematic view of a system and method of the present invention; and

FIGS. 3-6 are a flowchart representing a method of the present invention.

### DETAILED DESCRIPTION OF THE PREFERRED EMBODIMENTS

This invention comprises a system and method for recovering methane gas from landfills (LFG) and producing liquefied methane, commonly referred to as LNG (a quality motor fuel). This invention comprises a system for collecting the landfill gas, a system for purifying and liquefying the landfill gas and a system for storing and dispensing liquefied methane (and other byproducts).

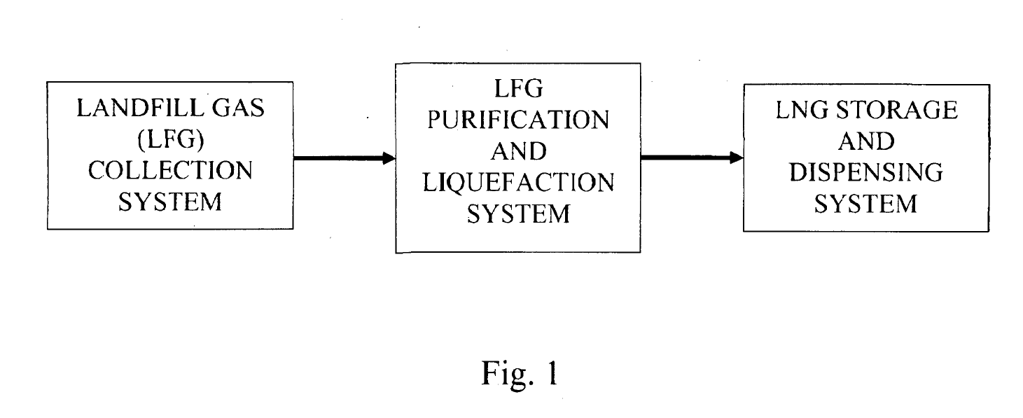

See FIG. 1.

Gas is produced in a landfill by anaerobic digestion of some of the deposited waste. Landfill gas generally consists of methane and carbon dioxide from the anaerobic digestion, nitrogen and oxygen from air that is drawn into the collection system, and a variety of sulfur and non-methane organic compounds from the waste itself. The tops of landfills are sealed so that the LFG cannot escape into the atmosphere because there may be deleterious components in the gas that are considered to be air pollutants.

The LFG collection system consists of a series of vertical or horizontal wells that convey the gas produced by anaerobic digestion to the inlet of a separator vessel. The separator vessel removes free water from the gas before the gas enters the inlet of a compressor. The LFG compressor raises the pressure of the LFG so that it can be delivered by pipeline to a flare where the combustible gases are incinerated before the LFG is discharged to the atmosphere, or the LFG gas is directed to the inlet of the LFG purification and liquefaction system, or to some other utilization method such as electrical power generation. The LFG collection system in itself is not unique to this invention.

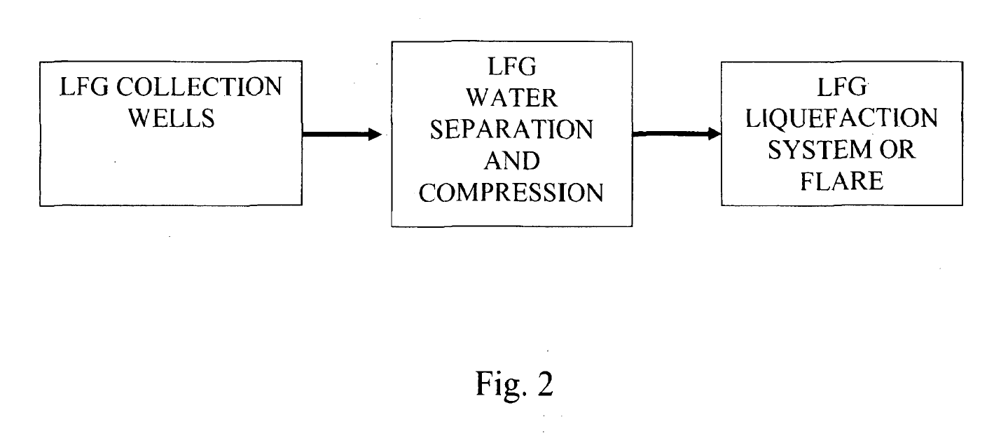

See FIG. 2.

The LFG liquefaction system consists of a series of processes that purify and liquefy the methane in the landfill gas and the system produces liquefied methane that is useful as a motor fuel or any other use that requires high purity methane, such as certain furnaces used in manufacturing processes. The LFG liquefaction plant consists of a purification process and a liquefaction process. The purification process removes the contaminants in the LFG, such as water and carbon dioxide, to a level that is compatible with the liquefaction process. This process operates in three modes: stand-by, production, and de-rime. The normal operating mode is the production mode.

The production mode is the normal operating mode and specific provisions have been made to optimize the plant operations by recycling gas flows to conserve landfill gas and increase production. These provisions are noted in each process step where they are present.

The stand-by mode is defined as the plant being ready to enter the production mode while maintaining safe pressures and temperatures in all parts of the plant. Specific provisions have been provided where required in the process. These provisions are noted in each process step where they are present.

Regarding the de-rime mode, from time to time, the heat exchangers and other parts of the low temperature systems may become coated with frozen water or carbon dioxide and must be warmed to a temperature above the freezing temperature with circulating warm gas to remove them.

Specific provisions are included in the production process system to accommodate all operating modes and to prevent the discharge of gas to the atmosphere, except via the landfill gas flare system, or in the event of a fire in the plant that might cause the pressure safety valves to open. These provisions are noted in each process step where they are present.

The following description is intended to be read in conjunction with the four(4) sheets of block diagrams appended to the end of the description.

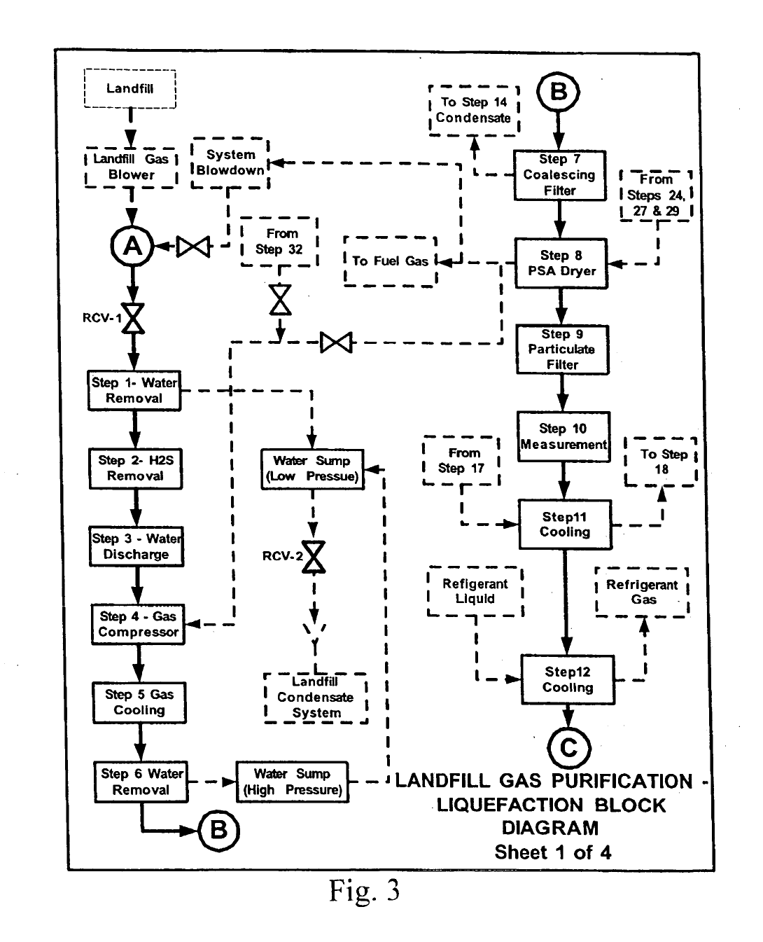

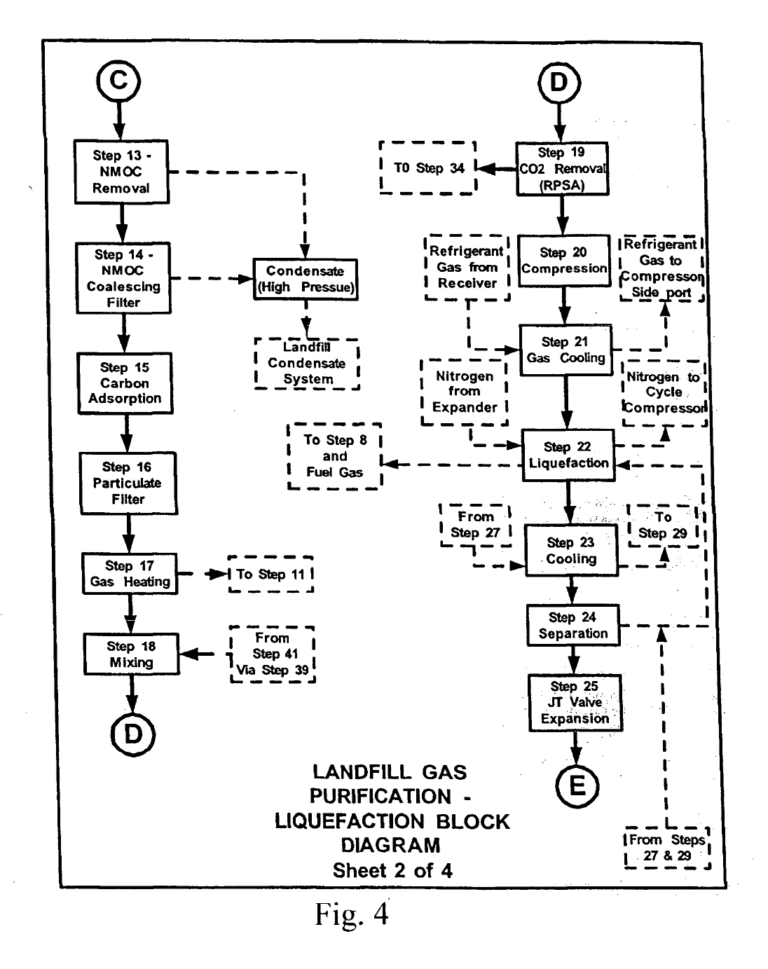

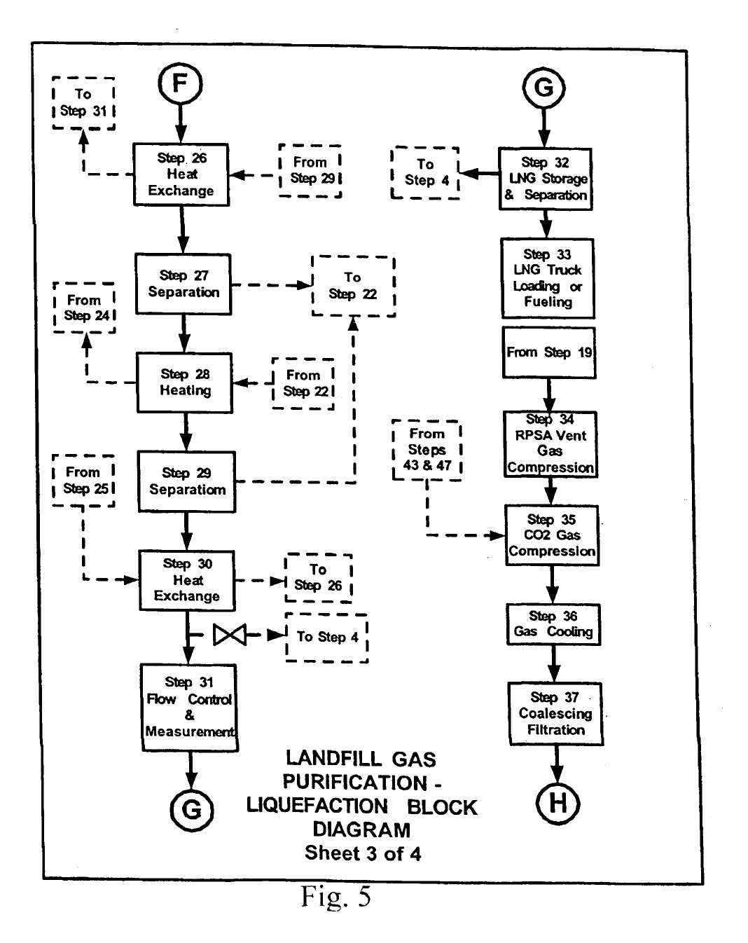

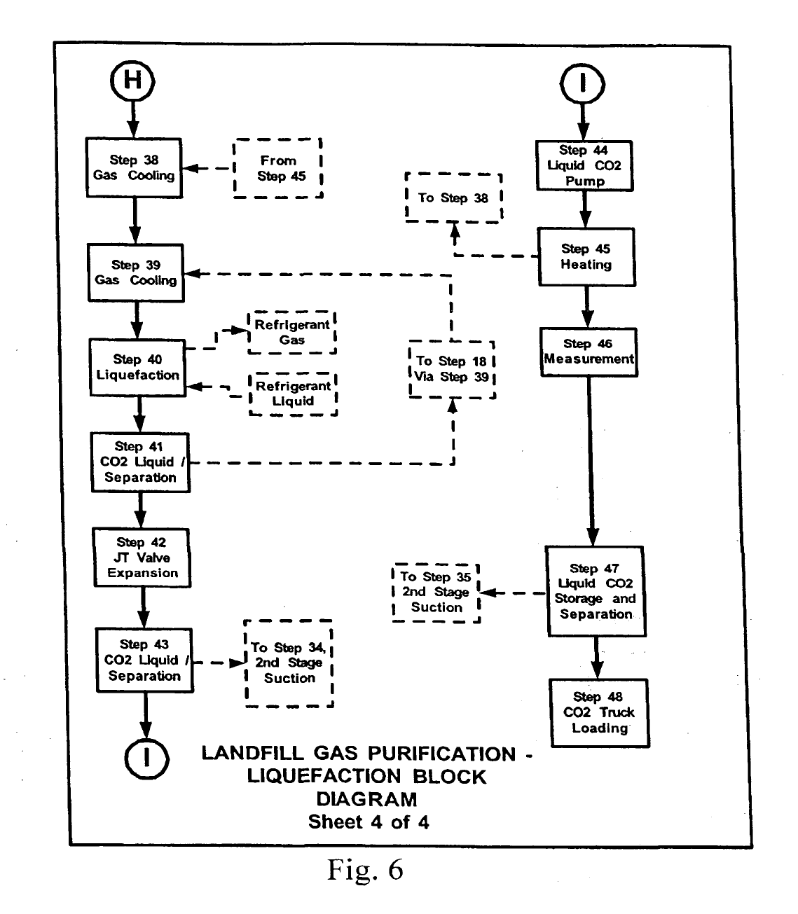

See FIGS. 3-6.

The LFG enters the purification and liquefaction process at a positive gauge pressure, 15 to 17 psia, via a remotely controlled valve. The remotely controlled valve (RCV-1) is used to isolate the liquefaction plant in the event of an emergency or when the liquefaction plant is shutdown.

The 1^{st} step in the purification process is the removal of any free water in the gas with a cyclonic coalescing separator constructed of 300 series austenitic stainless steel, located downstream of RCV-1. The removed water is piped to the bottom of the vessel described in step 2, via a pressure trap to prevent the flow of gas, where it is collected along with any water from steps 2 and 3.

The 2^{nd} step in the purification process employs a vessel filled with “iron sponge” adsorbent manufactured by various companies, such as “Sulfatreat”, specifically for the removal of hydrogen sulfide in gas streams, where the hydrogen sulfide reacts with the iron to form iron sulfate. Both the hydrogen sulfide absorbent and the spent adsorbent are non hazardous materials. The hydrogen sulfide absorber vessel is configured with a specially designed gas withdrawal device that ensures even flow distribution of the gas in the adsorbent thus improving the absorber efficiency.

The 3^{rd} step in the purification process is the removal of any free water from the bottom of the of the absorber vessel that was formed by the reduction in gas pressure and/or temperature at the bottom of the absorber, or that has been piped from steps 1 and 6. The water level in the bottom of the hydrogen sulfide removal vessel is monitored and the water is removed periodically to the leachate system of the landfill, or to an intermediate storage vessel where it is stored for removal by tanker truck, via a remotely controlled valve (RCV-2) that is programmed to open for an adjustable period at programmed interval.

The 4^{th} step in the purification process is the compression of the LFG to an elevated pressure of about 217 pound per square inch absolute (PSIA). The LFG compressor is configured with a pipe and control valve that allows the flow of cooled compressor discharge gas to the suction of the compressor when the compressor capacity control is set at minimum capacity, thus providing infinite control of the landfill gas into the downstream process.

The 5^{th} step in the purification process is the cooling of the compressed landfill gas to a temperature that is about 15 degrees Fahrenheit above ambient air temperature, by ambient air in a heat exchanger that has electric motor driven fans that cause air to pass by extended surface tubes that have the process gas inside the tubes and, since the temperature of the gas inside the tubes is higher than the temperature of the air on the outside of the tubes, thus the gas is cooled. The cooling fans are controlled via a temperature control system to allow the discharge gas temperature to rise to 150 dF during the de-rime operating mode.

The 6^{th} step in the purification process is the removal of any free water that has formed by the change in pressure and/or temperature using a coalescing cyclonic separator that is configured with a drainage vessel. The drainage vessel receives the water that has been separated, and discharges the water to the bottom of the vessel described in step 2. The drainage vessel is configured with water level measurement instrumentation that controls the discharge of the water and provides an operator alarm if the level of the water rises to a level that adversely effects the operation of the coalescing cyclonic separator.

The 7^{th} step in the purification process is the removal of any liquid or solid particles that may have passed the separator described in step 6 using a coalescing filter with a 10 micron filter element. This filter is configured with a drainage system that automatically drains any liquid from this filter to the condensate sump provided in Step 14. The drain is configured with a flow control valve and a flow indicator to allow the operator to determine if there is condensate flowing and when the condensate stops flowing.

The 8^{th} step in the purification process is drying the LFG in a pressure swing adsorber (PSA) that employs a molecular sieve as an adsorbent. The adsorbent in a pressure swing adsorber adsorbs water at high pressure and releases water at a low pressure with the assistance of a purge gas flow. The PSA employs two adsorber vessels in a parallel operation where one adsorber vessel is adsorbing water at high pressure and the other adsorber vessel is de-adsorbing water at low pressure and is purged with a flow of dry gas from steps 24, 27, and 29 of the liquefaction process. The PSA dryer reduces the water content of the LFG to a level of about 5 volumetric parts per million (5×10⁻⁶).

The 9^{th} step in the purification process is the removal of any particulate matter that may have been entrained in the drying process in step 8 filter with a twenty (20) micron filter element.

The 10^{th} step in the purification process is the analysis of the LFG with a gas chromatograph and the measurement of the LFG with a meter that provides values for pressure, temperature and flow.

The 11^{th} step in the purification process is the cooling of the LFG, to 12 dF, using a recuperative heat exchanger that recuperates the heat (refrigeration) from the gas exiting step 17 of the purification process in a counter flow process. The orientation/location of the heat exchanger is such that any organic condensate that might form from cooling the gas will flow by gravity to the next process step.

The 12^{th} step in the purification process is the cooling of the LFG stream to a temperature of about −40 dF. that will cause heavy hydrocarbon compounds (C₆+) to condense in a heat exchanger using a boiling refrigerant liquid such as ammonia, propane, or propylene. The temperature of the landfill gas is controlled by controlling the evaporating pressure of the refrigerant. The orientation/location/construction of this heat exchanger is such that any organic condensate that might form from cooling the gas will flow by gravity to the next process step.

The 13^{th} step in the purification process is the removal of any organic compounds that may have condensed due to reduced pressure and/or change in temperature of the LFG by a coalescing cyclonic separator and a coalescing filter, the combination of which will remove more than 99% of any liquid particles equal or greater in diameter than 5 microns (meter×10⁻⁶). The organic condensate removed from this separator is piped to a collection vessel that is shared by steps 7 & 14, in a manner that allows condensate to drain by gravity and prevent the flow of gas to step 14.

The 14^{th} step in the purification process is the further removal of non-methane organic compounds (NMOC) in the LFG using a coalescing filter with a 99.97% removal efficiency of all liquid or solid particles equal or greater than 0.5 micron (meter×10⁻⁶) in diameter. Condensate from this filter flows by gravity to the collection vessel described in step 13. The condensate collection vessel is configured with instrumentation that monitors the liquid level in the vessel, controls the discharge of liquid in the vessel to maintain a level, and provides an operator alarm for high and low level. The discharge of condensate is piped to a collection vessel where it is stored for periodic removal by conventional mobile equipment in accordance with applicable local regulations as hazardous waste.

The 15^{th} step in the purification process is the further removal of non-methane organic compounds (NMOC) in the LFG using activated carbon in a two vessel process configured with piping and valves such that the vessels may be configured to operate in series or parallel. The activated carbon (charcoal) absorbs non-methane organic compounds and metals, such as mercury, that could be detrimental to the materials of construction of the downstream process equipment. The LFG gas on inlet and outlet of the activated carbon is periodically sampled and analyzed in a gas chromatograph to determine the need for replacement of the carbon-absorbent. The piping is configured with block valves such that the carbon absorbent vessels may be isolated from the system when testing indicates levels of NMOC in excess of 1,000 volumetric parts per million. The spent carbon absorbent is mechanically removed from the absorption vessel and replaced with fresh absorbent. Spent carbon absorbent is recycled by the carbon supplier in a high temperature process. The carbon absorption system is configured with piping and a control valve to allow the process gas to bypass the absorption system during the de-rime operating mode.

The 16^{th} step in the purification process is the removal of any particulate matter that may have been entrained into the LFG gas stream in the carbon absorption process by a purchased particulate filter with a 0.5 micron filter element. The particulate filter is configured with block and bypass valves so that the element can be changed without de-pressuring the entire plant. The filter inlet and outlet piping is configured with two block valves and a vent valve between the two block valves so that the filter can be isolated, de-pressured, and opened while maintaining the personal safety of the operator.

The 17^{th} step in the purification process is the recovery of the refrigeration in the LFG in the recuperative heat exchanger in step 11 where the gas is heated to 60 dF.

The 18^{th} step in the LFG purification process is the mixing of the LFG gas stream with the methane rich exhaust gas stream from the carbon dioxide liquefaction process step 41, via step 39. The flow of the exhaust gas stream is analyzed by a gas chromatograph and measured by a meter that provides values for pressure temperature and flow before it is mixed in a pipe with the LFG gas flow.

The 19^{th} step in the purification process is the removal of carbon dioxide using a purchased rapid pressure swing adsorption (RPSA) system where the carbon dioxide is removed from the LFG stream in a process where CO2 is adsorbed by an adsorbent at high pressure, about 205 psia, and sent to the process gas outlet stream, and the CO2 is de-adsorbed by the adsorbent at low pressure of about 12 psia and sent to the vent stream. Thus the RPSA has one inlet stream, a process gas outlet stream and a vent gas outlet stream. The process gas outlet stream contains about 200 vppm of carbon dioxide and a percentage of the methane that was in the inlet gas stream. The vent, or exhaust, stream pressure is maintained by a compressor (blower) and the discharge of this compressor is piped to the carbon dioxide recovery system starting at step 34 . The RPSA is configured with a surge tank on each of the outlet streams. The surge tanks are designed to minimize the effects of flow/pressure oscillations in the stream in order to provide suction flow conditions that are consistent with the requirements of the downstream equipment.

The 20^{th} step in the purification/liquefaction process is the compression of the process gas stream from the rapid pressure swing adsorption system to a pressure of about 250 psia. This pressure is consistent with the requirements of the downstream liquefaction processes. The process gas compressor is configured with an inlet surge vessel that is designed to attenuate the pressure swings from the RPSA to a level suitable for the reliable operation of the process gas compressor. The process gas compressor is configured with an outlet surge vessel that is designed to attenuate the pulsations from the reciprocating process gas compressor to levels that are consistent with the design of the downstream liquefaction plant process. The process gas compressor is configured with a water-glycol cooling system that cools the compressor heads and the compressor oil. The discharge of the compressor is also configured with an oil separator that removes oil from the process gas to a level of about 1 vppm, and a coalescing filter that reduces the oil level in the process gas. The process gas compressor is configured with piping and controls to allow flow from the compressor discharge to the compressor suction which allows the compressor operation to be controlled for all process flow conditions.

The 21^{st} step in the purification/liquefaction process is the cooling of the process gas compressor discharge in a single pass counter flow heat exchanger with cold refrigerant gas on the cold side and warm process gas on the hot side.

The 22^{nd} step in the purification/liquefaction process is the refrigeration of the process gas in a multi-pass plate heat exchanger where the process gas is first cooled by a recuperative heat exchange with process vent gas, and is then cooled to partial liquefaction temperature by cold nitrogen gas. The cold nitrogen gas is produced in a closed loop refrigeration system where a nitrogen storage tank maintains the suction pressure of a nitrogen compressor, the nitrogen compressor raises the nitrogen pressure, then an air cooled heat exchanger, where electric motor driven fans move air across extended surface tube that contain the hot nitrogen gas, thus cooling the nitrogen gas, then the nitrogen passes through a coalescing filter that removes any oil from the nitrogen, then the nitrogen flows to the suction of an expander driven compressor that further raises the nitrogen, then the compressor discharge is cooled in an air cooled heat exchanger, as described above, then the nitrogen gas is filtered to remove any solid or liquid particles greater than 0.5 micron in diameter, then the nitrogen enters a multi-pass heat exchanger where it is cooled by a combination of heat sinks, then the cooled nitrogen is expanded in the radial in-flow gas turbo-expander that powers the booster compressor, thus cooling the nitrogen gas to a temperature that is consistent with the liquefaction of methane at the discharge pressure of the booster compressor, then the cool nitrogen enters the multi-pass heat exchanger where it cools the process gas, then the nitrogen flows back to the suction of the nitrogen compressor via a heat recovery path in the multi-pass heat exchanger. A piping system with control valve is provided to allow process gas to by-pass the multi-pass heat exchanger in order to control the temperature of the gas/liquid flowing to step 23.

The 23^{rd} step in the purification/liquefaction process is the cooling of the process gas/liquid stream from −202 dF to −216 dF in a plate heat exchanger where the process gas/liquid flows through the warm pass of the heat exchanger and sub-cooled process gas from step 27 that flows in a counter current configuration in the cold pass of the heat exchanger.

The 24^{th} step in the purification/liquefaction process is the separation of nitrogen and oxygen from the process gas in a residence time separator where the flow velocity of process gas/liquid mixture is reduced and a separation space and flow path is provided for gaseous constituents in the process gas/liquid. The gaseous portion of the flow stream exits the top of the separator via a de-mister device that is designed to coalesce liquid droplets from the gas flow and return the liquid to the separator. The pressure in this separator is maintained by a pressure control valve in the gaseous vent line from the separator. The gas flow from the separator is mixed with the gas flow from the separators in steps 27 and 29 and then flows to the multi-pass heat exchanger in step 22 where the refrigeration in the gas is recovered in a recuperative heat exchange process. This vent gas is employed to purge the adsorbent in the pressure swing dryer in step 8 of this process, and the wet gas is mixed with landfill gas upstream of the refrigerated dryers in the fuel gas processing for the engine generator set that powers this process, or is sent to flare.

The 25^{th} step in the purification/liquefaction process is the refrigeration of the process gas stream by the Joules Thompson effect where the pressure is lowered by expansion of the high pressure liquid stream in a valve to a lower pressure. The outlet of the expansion valve is a mixture of gas and liquid at about 38 psia and −260 dF.

The 26^{th} step in the purification/liquefaction process is the cooling of the liquid stream from step 29 by the cold liquid from step 25 in a counter flow heat exchanger.

The 27^{th} step in the purification/liquefaction process is the separation of the gaseous fraction of the warm stream from step 26 in a residence time separator configured with a coalescing device that removes any liquid particles from the vent that exits the top of the separator where it mixes with the vent gas from step 24. The liquid in the separator flows by gravity to the recuperative heat exchanger in step 23.

The 28^{th} step in the purification/liquefaction process is the heating of the liquid stream by electrical heaters to adjust the temperature of the liquid from about −246 dF to about −245 dF, to prepare for the final separation of inert gases.

The 29^{th} step in the purification/liquefaction process is the separation of inert gases from the liquid methane in a residence time separator where the gaseous portion is vented from the top of the separator via a coalescing device that removes any liquid particles from the stream before it mixes with the vent gas from steps 27 and 24. The liquid in the bottom of the separator flows to step 30.

The 30^{th} step in the purification/liquefaction process is the control of the level in the separator described in step 29 by a valve that is controlled by the liquid level in the separator and the discharge of the valve flows to the heat exchanger described in step 26 where it is sub-cools the liquid on the warm side of the exchanger. The system is configured with piping and a control valve so that the system flow may be directed to the suction of the landfill gas compressor described in step 4 during system start-up and during the de-rime operating mode.

The 31^{st} step in the purification/liquefaction process is measurement of the flow from step 30 for temperature, pressure, and composition, and then the liquid flows in an insulated pipe to an insulated storage tank.

The 32^{nd} step in the purification/liquefaction process is the final separation of liquid and gas in a storage tank that is configured with an inlet flow distribution device that distributes the inlet flow evenly with 20 flow outlets along the bottom of the horizontal storage vessel. The storage vessel is an insulated tank with a calculated heat flow from the surrounding atmosphere to the stored cryogenic liquid. This heat flow heats the stored liquid which causes a thermal separation of gas with a lower boiling point to evolve from the liquid as a gas. The evolved gases are collected in a constant velocity collection system that ensures that the flow of gases is evenly distributed above the gas/liquid surface of the stored liquid. The gaseous flow from the storage tank flows to the suction of the compressor described in step 3 via a pressure control valve. The control valve maintains a constant pressure in the storage tank. This pressure may be changed depending upon the composition of the LFG being processed to produce liquid methane gas that is consistent with the quality requirements of the consumer.

The 33^{rd} step in the purification/liquefaction process is the removal of liquid from the storage tank on a periodic basis via a pump that is connected to the bottom of the storage tank at one end of the tank so that the withdrawal of liquid causes a minimum disturbance of the stored liquid.

The 34th step in the purification/liquefaction process is the removal of the vent gas from the carbon dioxide removal system in step 19 where the vent gas flows to the suction of a positive displacement compressor via a surge tank. The surge tank is specifically configured to reduce the pressure fluctuations in the vent gas stream to minimize the transmission of pressure fluctuations to the discharge of the vent gas compressor. The vent gas compressor maintains a minimum suction pressure of about 12 psia on the vent of the carbon dioxide removal system to maximize the capacity of the adsorbent beds in the carbon dioxide removal system and discharges the vent gas at about 17 psia. The flow from the vent gas compressor is measured for flow, pressure, temperature, and composition.

The 35^{th} step in the purification/liquefaction process is the compression of the discharge of the vent gas compressor from about 17 psia to about 320 psia, by the carbon dioxide compressor in a two stage gas compression process. Each compressor is configured with piping and controls to allow the discharge of the compressor to flow to the suction of the compressor in order to provide an infinite control of the compressor flows in combination with the compressor capacity controls.

The 36^{th} step in the purification/liquefaction process is the cooling of the carbon dioxide compressor discharges from inter-stage and final discharge cooling with air cooled heat exchangers where electric motor driven fans move ambient temperature air across extended surface tubes that contain the compressed gas, thereby cooling the hot compressed gas to a temperature equal to that of the ambient air plus about 15 dF. The electric fans are controlled during the de-rime operating mode to provide warm gas for the de-rime of the carbon dioxide system components.

The 37^{th} step in the purification/liquefaction process is the removal of trace amounts of oil in the compressed gas stream by a coalescing filter separator.

The 38th step in the purification/liquefaction process is the cooling of the compressed gas to a temperature of about 70 dF in a heat exchanger by a controlled flow of liquid carbon dioxide from step 44. The temperature of the liquid carbon dioxide is controlled by bypassing the heat exchanger to maintain a constant temperature that ensures the carbon dioxide does not become solid.

The 39^{th} step in the purification/liquefaction process is the cooling of the compressed gas to a temperature of about 5 dF in a recuperative counter flow heat exchanger by the methane recycle gas flow from step 41. The temperature of the compressed gas flow is controlled by bypassing compressed gas around the heat exchanger via a temperature control valve.

The 40^{th} step in the purification/liquefaction process is the refrigeration of the compressed gas to a temperature of about −41 dF in a counterflow heat exchanger configured with boiling propylene on the cold pass and compressed gas on the hot pass. The compressed gas liquid mixture flow out of the heat exchanger by gravity to step 41.

The 41^{st} step in the purification/liquefaction process is the separation of methane from the liquid carbon dioxide in a high pressure residence time separator where the methane, and other gaseous components, flows out of the top of the separator to step 39. The liquid flows out of the bottom of the separator to a Joules Thompson valve.

The 42^{nd} step in the purification/liquefaction process is the cooling of the flow from step 41 from about −41 to −64 dF by the reduction in pressure in a Joules Thompson valve which results in a reduction of temperature and converts the liquid flow into a mixture of gas and liquid that flows to step 43.

The 43^{rd} step in the purification/liquefaction process is the separation of gas from liquid in a residence time separator where the gaseous portion of the stream exits the top of the separator via a coalescing filter and flows to the suction of the second stage CO2 compressor for recycling into the compressed gas stream.

The 44th step in the purification/liquefaction process is the maintenance of the level in the separator described in step 41 where the liquid flows from the bottom of the separator to a pump in step 45 that is controlled by a liquid level controller on the separator.

The 45th step in the purification/liquefaction process is the raising of the liquid CO2 to a pressure that is required for the storage of the liquid at a desired temperature and the liquid flows to the heat exchanger described in step 36.

The 46th step in the purification/liquefaction process is the heating of the CO2 liquid to a temperature of about −19 dF in the heat exchanger described in step 36, then the liquid flow is measured for flow, temperature, pressure, and composition, and then flows to the CO2 storage tank via an insulated pipeline.

The 47^{th} step in the purification/liquefaction process is the final separation of inert gasses from the liquid carbon dioxide in a pressurized storage tank that is configured with an inlet flow distribution device that distributes the flow evenly along the bottom of the horizontal storage tank. The CO2 storage tank is an insulated vessel where heat flows from the atmosphere through the insulation to the cold CO2 stored in the tank and causes the impurities in the CO2 to change from a liquid to a gas and rise to the surface of the liquid in the tank, where they are removed by a constant velocity vapor removal piping system that removes the gas from the tank. The evolved gases flow out of the storage tank and are returned to the inlet of the second stage CO2 compressor described in step 35

The 48^{th} step in the purification and liquefaction process is the loading of transport vehicles by a pump from the carbon dioxide storage tank.

What is claimed is:

1. A process for manufacturing liquid methane from a feedstock gas, wherein the feedstock gas is obtained from an alternative gas source generated by anaerobic digestion and comprising methane, carbon dioxide, nitrogen, oxygen, water vapor and hydrogen sulfide, the process comprising the steps of:
(i) removing from the feedstock gas constituents which are incompatible with liquefaction, wherein removal is effected by pressure swing absorption, whereby to yield a mixture comprising methane, nitrogen and oxygen; and
(ii) liquefying the mixture by cooling, and adjusting the temperature during cooling so as to remove nitrogen and oxygen, whereby to yield an output consisting primarily of liquid methane.
